(19) United States
(12) Patent Application Publication
(10) Pub. No.: US 2015/0023188 A1
(43) Pub. Date: Jan. 22, 2015

(54) COMPARATIVE ANALYSIS OF WIRELESS DEVICES

(71) Applicant: Azimuth Systems, Inc., Acton, MA (US)

(72) Inventors: Deepak Das, Arlington, MA (US); Nandish Chalishazar, Nashua, NH (US); Eric Ely, Goffstown, NH (US)

(73) Assignee: Azimuth Systems, Inc., Acton, MA (US)

(21) Appl. No.: 14/270,529

(22) Filed: May 6, 2014

Related U.S. Application Data
(60) Provisional application No. 61/846,910, filed on Jul. 16, 2013.

(51) Int. Cl. H04W 24/10

(52) U.S. Cl. CPC H04W 24/10
USPC 370/252

(57) ABSTRACT

A plurality of wireless devices which communicate with at least one other device are simultaneously tested using a test regime which includes a plurality of corresponding comparative tasks. Commencement of each task by all wireless devices is synchronized. Test results are analyzed and a side-by-side comparison is provided on an overall, per task type, and per task basis.

### CROSS-REFERENCE TO RELATED APPLICATIONS

This application claims the benefit of U.S. Provisional Application No. 61/846,910 filed Jul. 16, 2013, titled “Unified Diagnostics and Analysis for Synchronized Mobile Device Testing,” which is incorporated by reference.

### BACKGROUND

The subject matter of this disclosure is generally related to the testing of wireless devices. Examples of wireless devices include but are not limited to mobile phones, base stations, wireless routers, cordless phones, personal digital assistants (PDAs), desktop computers, tablet computers, and laptop computers. Testing of a wireless device may be desirable for any of a wide variety of reasons. For example, testing can be done in the product development stage in order to determine whether a prototype wireless device functions as predicted. Testing may also be useful for determining whether production wireless devices perform within specifications, and also for identifying causes of malfunctions.

### SUMMARY

All examples and features mentioned below can be combined in any technically possible way.

In one aspect a method comprises: simultaneously testing a plurality of wireless devices which communicate with at least one other device using a test which includes a plurality of tasks by: synchronizing commencement of corresponding comparative tasks by all wireless devices; logging performance of each wireless device during the test; calculating values of at least one performance indicator for each wireless device for at least one of the tasks; and providing an output which compares the performance indicators. Implementations may include one or more of the following features in any combination. Calculating said values may comprise calculating values of at least one performance indicator for each wireless device for multiple tasks of a selected type. Calculating said values may comprise calculating values of at least one overall performance indicator for each wireless device for multiple tasks of multiple selected types. The method may include identifying per task performance indicators having predetermined out-of-specification characteristics. The method may include identifying per task type performance indicators having predetermined out-of-specification characteristics. The method may include identifying overall performance indicators having predetermined out-of-specification characteristics.

In accordance with another aspect a computer program stored on non-transitory computer-readable memory comprises: instructions which cause a plurality of wireless devices which communicate with at least one other device to be simultaneously tested using a test which includes a plurality of tasks, and comprising instructions which: synchronize commencement of corresponding comparative tasks by all wireless devices; log performance measurements of each wireless device for each task; calculate values of at least one performance indicator for each wireless device for at least one of the tasks; and provide an output which compares the performance indicators. Implementations may include one or more of the following features in any combination. The computer program may comprise instructions which calculate values of at least one performance indicator for each wireless device for multiple tasks of a selected type. The computer program may comprise instructions which calculate values of at least one overall performance indicator for each wireless device for multiple tasks of multiple selected types. The computer program may comprise instructions which identify per task performance indicators having predetermined out-of-specification characteristics. The computer program may comprise instructions which identify per task type performance indicators having predetermined out-of-specification characteristics. The computer program may comprise instructions which identify overall performance indicators having predetermined out-of-specification characteristics.

In accordance with another aspect an apparatus comprises: a test system in which a plurality of wireless devices which communicate with at least one other device are simultaneously tested using a test which includes a plurality of tasks, comprising one or more devices which: synchronize commencement of corresponding comparative tasks by all wireless devices; log performance measurements of each wireless device for each task; calculate values of at least one performance indicator for each wireless device for at least one of the tasks; and provide an output which compares the performance indicators. Implementations may include one or more of the following features in any combination. The one or more devices may calculate values of at least one performance indicator for each wireless device for multiple tasks of a selected type. The one or more devices may calculate values of at least one overall performance indicator for each wireless device for multiple tasks of multiple selected types. The one or more devices may identify per task performance indicators having predetermined out-of-specification characteristics. The one or more devices may identify per task type performance indicators having predetermined out-of-specification characteristics. The one or more devices may identify overall performance indicators having predetermined out-of-specification characteristics.

### BRIEF DESCRIPTION OF THE FIGURES

FIG. 1 illustrates synchronized wireless device test logs.

FIGS. 2 and 3 illustrate methods of synchronized testing of DUTs.

FIG. 4 illustrates a tethered, Open-Air (OA) test system.

FIG. 5 illustrates an untethered OA test system with master and slave devices.

FIG. 6 illustrates an untethered OA test system in which synchronization is provided with assistance from a network device.

FIG. 7 illustrates generation of a DUT comparison report from test data.

FIG. 8 illustrates presentation of global parameters in the DUT comparison report.

FIG. 9 illustrates presentation of sector-level parameters in the DUT comparison report.

FIG. 10 illustrates presentation of a download summary in the DUT comparison report.

FIG. 11 illustrates presentation of a upload summary in the DUT comparison report.

FIG. 12 illustrates presentation of an application-independent summary in the DUT comparison report.

FIGS. 13 through 16 illustrate presentation of task type summaries in the DUT comparison report.

FIG. 17 illustrates presentation of per DUT statistics in the DUT comparison report.

FIG. 18 illustrates presentation of per DUT log reports in the DUT comparison report.

### DETAILED DESCRIPTION

Some aspects, implementations, features and embodiments comprise computer components and computer-implemented steps that will be apparent to those skilled in the art. For example, it should be understood by one of skill in the art that the computer-implemented steps may be stored as computer-executable instructions on a computer-readable medium such as, for example, floppy disks, hard disks, optical disks, Flash ROMS, nonvolatile ROM, and RAM. Furthermore, it should be understood by one of skill in the art that the computer-executable instructions may be executed on a variety of processors such as, for example, microprocessors, digital signal processors, gate arrays, etc. For ease of exposition, not every step or element of the systems and methods described above is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the disclosure. Moreover, the features described herein can be used in any of a wide variety of combinations that are not limited to the illustrated and described examples.

Known systems for testing wireless devices generate data which includes various performance measurements. Although such systems can provide detailed information about the operation of a single wireless device, hereafter Device Under Test (DUT) or User Equipment (UE), it is difficult to compare different DUTs from the performance measurements. For example, even if two DUTs are subjected to the same test it is not always clear from the test data when each DUT begins and finishes performing particular functions. Moreover, if the DUTs perform the same function at different periods of time then the results may not be meaningfully comparable if the functions are performed under different channel conditions. Consequently, it is difficult to conduct an “apples to apples” comparison of DUTs, particularly when they are tested in an uncontrolled environment. This is problematic not only because there is a need for meaningful comparison of different models of DUTs, but also because there is a need for meaningful comparison of the same model of DUT where a particular DUT functions as a reference standard for comparison purposes.

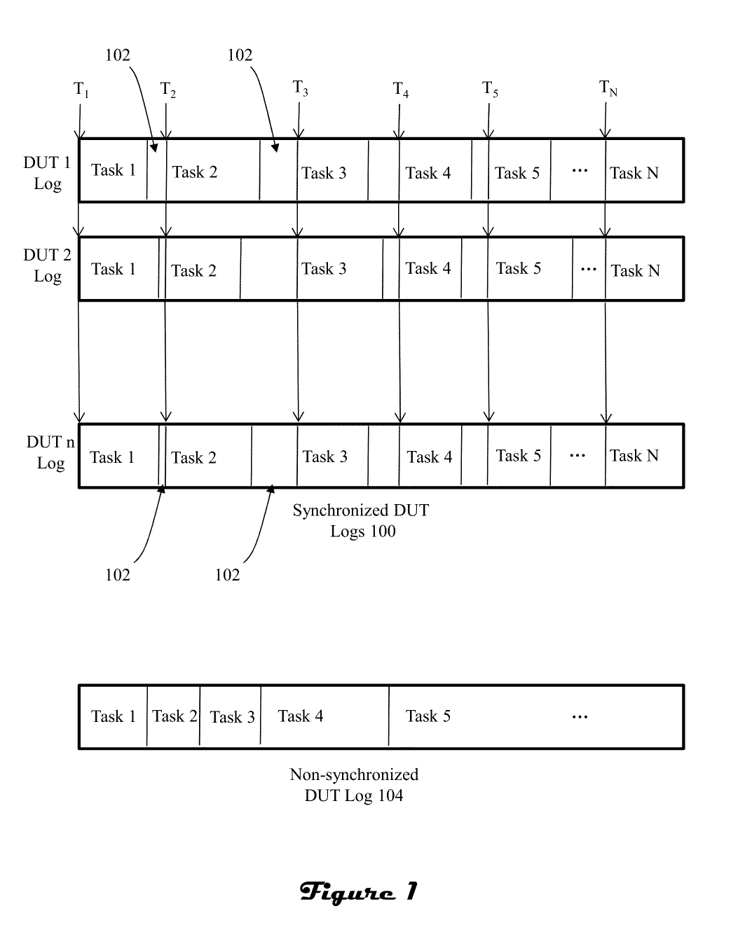

FIG. 1 illustrates log files 100 (DUT 1 Log through DUT n Log) associated with a wireless device testing technique which facilitates meaningful comparison of different DUTs, different networks, different services and other features. In order to generate the test logs multiple DUTs (DUT1 through DUT n) are simultaneously subjected to the same test regime which includes multiple discrete tasks (Task 1 through Task N). As indicated by start times T₁ through T_{N}, performance of corresponding tasks is synchronized. More particularly, the start time for performing each test task is synchronized such that each DUT begins Task 1 at the same time, Task 2 at the same time, Task 3 at the same time, and so forth, regardless of when the previous task was completed by the DUT. In the illustrated example start times T₁ through T_{N} correspond to initiations of Task 1 through Task N, respectively. Synchronization of start times helps to ensure that corresponding tasks are performed by each DUT under the same channel conditions. Consequently, comparison is more meaningful relative to a non-synchronized DUT log 104 which would show performance of the tasks under potentially different channel conditions because start times would vary and channel conditions change over time.

Another aspect of the synchronized test logs is that test data portions associated with performance of specific tasks is readily recognizable. As will be explained in greater detail below, all of the DUTs in the test are provided adequate time to finish each assigned task before the synchronized start of the next task. Moreover, the synchronized start times can be selected to produce a recognizable quiet interval 102 which is presented between temporally adjacent task data in the log files. The known start times and recognizable quiet intervals help algorithms to automatically identify and extract performance results for each discrete task. Consequently, performance of individual tasks can be analyzed, and it may be readily apparent if one or more specific tasks had a significant influence on overall performance of one or more of the DUTs, thereby helping to pinpoint problems.

A wide variety of types of tasks may be utilized. Examples of types of tasks include, without limitation, streaming a video, downloading a web page, uploading a photo or video, performing a voice call, and performing a video call. The tasks may be organized by type, and multiple tasks of the same type may be included in the test, as well as different types of tasks. For example, a test may include downloading multiple different web pages and uploading multiple different videos. Moreover, a test may include iterations of the same task, e.g., downloading the same web page multiple times and uploading the same video multiple times.

A wide variety of tasks may be utilized. Factors which characterize individual tasks as being “the same task” for all DUTs may be determined by the operator. For example and without limitation, streaming the same video file from the same server over the same network may be considered the same task. However, streaming the same video from different servers associated with the same server farm, or streaming different videos of equivalent or similar size from different servers having equivalent or similar performance may, or may not, be considered the same task as determined by the operator. Whatever defining factors are selected, causing inputs including but not limited to channel conditions to be equivalent or identical for all DUTs in the test will generally facilitate comparison of the performance of each DUT with the other DUTs in the test by mitigating differences in performance which are attributable to devices other than the DUTs. However, the system is not limited to comparison of different DUTs by mitigating differences in all other factors which affect performance. For example, different networks, network devices, services and other features can be analyzed and compared by using identical DUTs. In some aspects differences between corresponding tasks may be desirable. For example, two identical DUTs could be tested side by side such that they simultaneously upload or download the same data (e.g., video, web page etc.) via different carrier networks or from different sources in the same network, e.g., a locally cached source versus a source that is logically or geographically more distant. This can allow comparison of aspects and elements other than the DUTs, e.g., different carrier networks and network infrastructure. Moreover, different DUTs could be used when different corresponding tasks are used to isolate a feature for analysis and comparison. For example, a service offered by a first carrier could be tested with the first carrier's DUT at the same time that a similar or equivalent service offered by a second carrier is tested with the second carrier's DUT (which may be a different make or model than the first carrier's DUT), thereby providing a meaningful side-by-side comparison of service offerings with available infrastructure under the same channel conditions. The corresponding tasks which are synchronously begun by the DUTs may therefore be considered as comparative tasks which encompass both the situation where the tasks are the same or identical, and the situation where there are differences between the tasks.

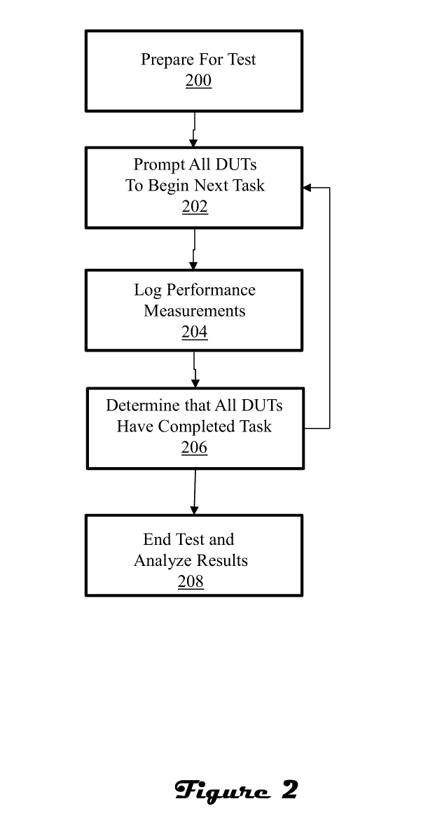

FIG. 2 illustrates a method of synchronized testing of DUTs. An initial step 200 is to prepare for the test. Preparing for the test may include a wide variety of actions depending on the type of test being performed, but generally includes causing the DUTs to begin communication and to become associated with another device in preparation for synchronized performance of assigned tasks. In step 202 all of the DUTs in the test are prompted to simultaneously begin a first assigned task which is selected from a group of multiple corresponding comparative tasks, e.g., Task 1 of Tasks 1 through N (FIG. 1). As indicated in step 204, DUT performance measurements for the assigned task are separately logged for each DUT in the test. For example, a separate log file may be generated for each DUT, e.g., DUT 1 Log through DUT n Log (FIG. 1). The log files may contain a wide variety of performance measurements including but not limited to one or more of power measurements (e.g., interference, noise, signal-to-noise ratio (SNR), received signal strength indicator (RSSI), and multipath Power-Delay-Profile), multiple-input multiple-output (MIMO) correlation, cell information, sector information, location information, data rate, throughput, wireless channel signal quality, and handoff parameters. Logging of performance measurements for each DUT may continue after the task has been completed, e.g., including logging of the quiet interval. A new task, e.g., Task 2, is not started until it is determined that all DUTs have completed the assigned task as indicated in step 206. Determining that a DUT has completed the assigned task may include causing the DUT to send an indication of task completion to one or more other devices, e.g., by software loaded on the DUT. The DUT may also be queried by one or more other devices for task completion status. Further, another device may independently determine whether the DUT has completed the task, e.g., by passively monitoring DUT activity via snooping or other techniques. Once it has been determined that all DUTs have completed the assigned task then a new task is selected and assigned. In particular, all DUTs are prompted to begin the next corresponding comparative task at the same time as indicated in step 202. Steps 202 through 206 continue in an iterative manner until all of the tasks of the test regime have been performed. The test is then ended and the results may be analyzed as indicated in step 208. For example, specific performance measurements for different DUTs, networks, devices, services or other features may be compared. Comparison may be presented on a per-task basis, and outlier data associated with one or more tasks may be flagged or removed from overall performance computations.

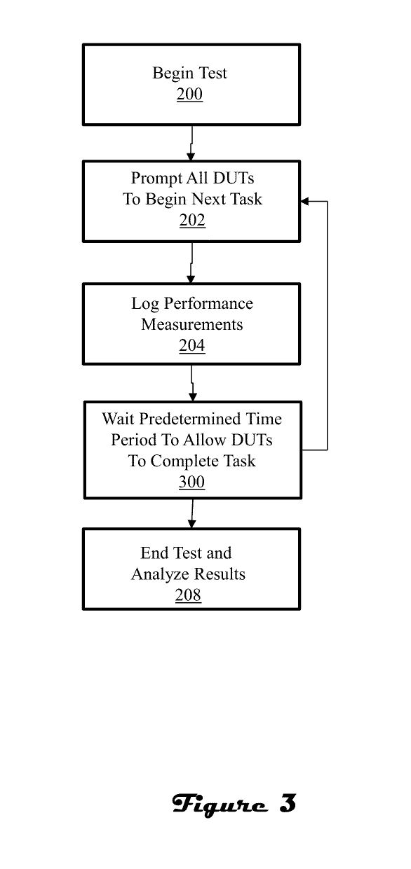

FIG. 3 illustrates another method of synchronized testing of DUTs. Steps with the same reference numbers as those in FIGS. 2 (200, 202, 204, and 208) operate as described with respect to that figure. This method is similar to the test described with respect to FIG. 2 except that a predetermined period of time is used as indicated in step 300 rather than determining that all DUTs have completed the task. The predetermined period of time may be selected by the operator such that all DUTs should be able to complete the task within that period of time. Different tasks may be expected to require different amounts of time to complete so different periods of time may be associated with different tasks. The time utilized to determine the period between the start of corresponding comparative tasks may be real time or test time. For example, the start times may be specific times of day based on a real-time clock, or they may be elapsed times based on a counter, e.g. a counter which is reset at the beginning of each task or each test. Once the predetermined period of time for the currently assigned task has elapsed then another task is selected and all DUTs are prompted to begin the new task at the same time as indicated by step 202. Steps 202, 204 and 300 continue in an iterative manner until all of the tasks have been performed. The test is then ended and the results may be analyzed as indicated in step 208. For example, specific performance measurements for different DUTs may be compared on a per-task basis.

A wide variety of testing systems can be use in accordance with the techniques described above, including but not limited to conducted testing system, Over-The-Air (OTA) testing systems, and Open Air (OA) testing systems. A conducted testing system typically includes at least one signal transmission device, a channel emulator, a playback file, EMI-shielding containers, and a test control module. Each DUT is enclosed in a separate one of the EMI-shielded containers and the DUT antennas are bypassed with direct wired connections. The signal transmission device or devices may include device emulators, real devices such as base stations, access points or controllers, without limitation, or a mix of real devices and device emulators. The channel emulator is used to simulate channel conditions during the test by processing signals transmitted between the signal transmission device and the DUTs. In particular, the channel emulator processes the signals which it receives by subjecting those signals to simulated channel conditions specified by the playback file. The channel conditions may include, but are not limited to, multipath reflections, delay spread, angle of arrival, power angular spread, angle of departure, antenna spacing, antenna geometry, Doppler from a moving vehicle, Doppler from changing environments, path loss, shadow fading effects, reflections in clusters and external interference such as radar signals, phone transmission and other wireless signals or noise. The playback file may be based on log files from a real network environment, modified log files from a real network environment, or a hypothetical network environment. Performance measurements captured from or by the DUTs, such as data rate or throughput for example and without limitation, may be provided to the test control module for storage (logging) and analysis. The test control module might also or alternatively maintain the master clock if synchronization is based on waiting a predetermined period of time to allow the DUTs to complete the task. The master clock could be utilized to measure the predetermined period of time (step 300, FIG. 3). OTA testing systems may include similar devices to the conducted testing system, but a reverberation chamber or anechoic chamber is utilized rather than the EMI-shielded container, thereby enabling the DUT to be tested in its native state via the DUT antennas. It should be noted that the test control module is not necessarily used in every configuration. For example, the DUTs and the signal transmission device might generate their own log files. A distributed program, or coordinated programs running on different devices, could be used to implement the methods described above, including but not limited to step 206 of FIG. 2 and step 300 of FIG. 3. It should be noted that conducted and OTA testing systems present controlled environments so DUTs may be tested non-contemporaneously and the results may be suitable for comparison.

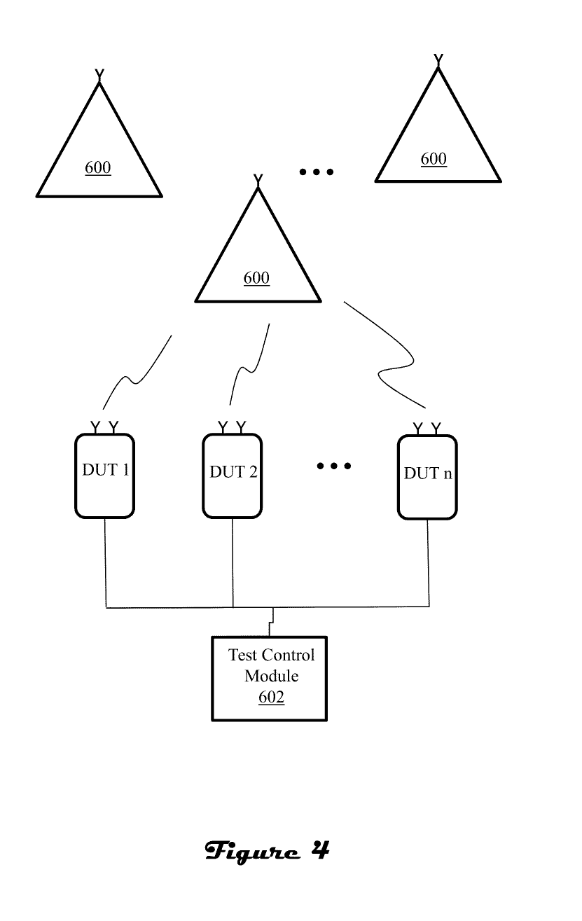

FIG. 4 illustrates a tethered, Open-Air (OA) test system in accordance with the techniques described above. OA testing of wireless devices may be performed by moving the DUTs (DUT 1 through DUT n) together within a partly or completely uncontrolled environment while measuring various performance parameters which are stored in the log files (DUT 1 Log through DUT n Log, FIG. 1). For example, the DUTs may be moved through a real access network which includes various access devices 600 such as base stations and wireless access points with which the DUTs may associate and communicate. The access devices may be connected to a wired network through which various servers and other devices can be accessed. A test control module 602 may synchronize the DUTs, e.g. by determining that all DUTs have completed a task before prompting all DUTs to beginning the next task. The test control module might also maintain the master clock if synchronization is based on waiting a predetermined period of time to allow the DUTs to complete the task. A distributed program, or coordinated programs running on different devices, could be used to implement the methods described above, including but not limited to step 206 of FIG. 2 and step 300 of FIG. 3.

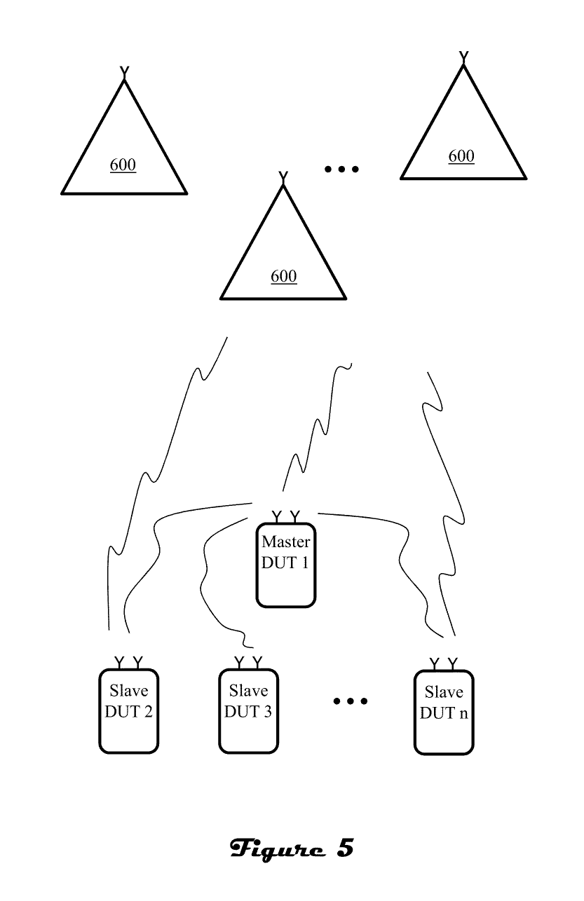

FIG. 5 illustrates an untethered OA test system in accordance with the techniques described above. The DUTs (DUT 1 through DUT n) operate together within a partly or completely uncontrolled environment while various DUT performance parameters are measured and stored in the log files (DUT 1 Log through DUT n Log, FIG. 1). For example, the DUTs may be moved through a real network which includes various access devices 600 such as base stations and wireless access points with which the DUTs may associate and communicate. The access devices may be connected to a wired network through which various servers and other devices can be accessed. One of the DUTs, e.g., DUT 1, is designated as the master device. The other DUTs, e.g., DUT 2 through DUT n, are designated as slave devices. The master device is equipped with a master control program that controls synchronization among the DUTs, and the slave devices may be equipped with slave control programs that communicate with the master program. For example, the DUTs may form an ad hoc local wireless network via which the programs can communicate. The master device may synchronize the DUTs by determining that all DUTs have completed a task before prompting all DUTs to begin the next task. The master device might also or alternatively maintain a master clock. If synchronization is based on waiting a predetermined period of time to allow the DUTs to complete the task then packets with appropriate timestamps, markers or time pulses may be broadcast to the slave devices from the master device via the ad hoc network to synchronize task start times. The DUTs may generate their own log files. The program or programs running on the DUTs implement the methods described above, including but not limited to step 206 of FIG. 2 and step 300 of FIG. 3.

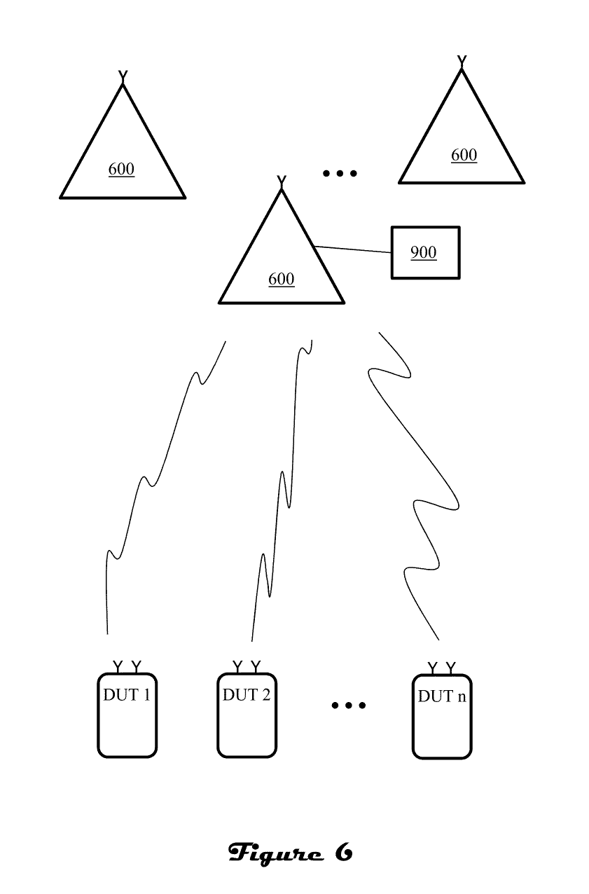

FIG. 6 illustrates another untethered OA test system in accordance with the techniques described above. The system is similar to the system described with respect to FIG. 5 except that there are no master device and slave device designations, and synchronization is controlled by one or more network devices such as an access device 600. An access device 600 may synchronize the DUTs by determining that all DUTs have completed a task before prompting all DUTs to begin the next task. The access device might also or alternatively maintain a master clock. If synchronization is based on waiting a predetermined period of time to allow the DUTs to complete the task then packets with appropriate timestamps, markers or time pulses may be broadcast to the DUTs from the network access device to synchronize task start times. The DUTs may generate their own log files. A program or programs running on the DUTs may help implement the methods described above, including but not limited to step 206 of FIG. 2 and step 300 of FIG. 3.

It is also possible to utilize a network device 900 other than an access device 600 to synchronize the DUTs (DUT 1 through DUT n). For example, the DUTs may register with a network device such as a server that synchronizes the DUTs by determining that all DUTs have completed a task before prompting all DUTs to begin the next task. The server might also or alternatively maintain a master clock. If synchronization is based on waiting a predetermined period of time to allow the DUTs to complete the task then packets with appropriate timestamps, markers or time pulses may be broadcast to the DUTs from the server to synchronize task start times. The DUTs may maintain their own log files. A program or programs running on the DUTs may help implement the methods described above, including but not limited to step 206 of FIG. 2 and step 300 of FIG. 3.

In the examples described above and variations thereof, robustness in terms of periodic or trigger-based timing resynchronization, graceful behavior in the cases of loss of timing synchronization, failure reporting and ability to switch between modes, as appropriate, may be provided. Graceful behavior in the case of loss of timing synchronization may include use of wait periods between tests, wait periods followed by retries to acquire timing synchronization, appropriate warning to the operator, and ability to free-run without timing synchronization for a meaningful duration or up to a certain predefined event.

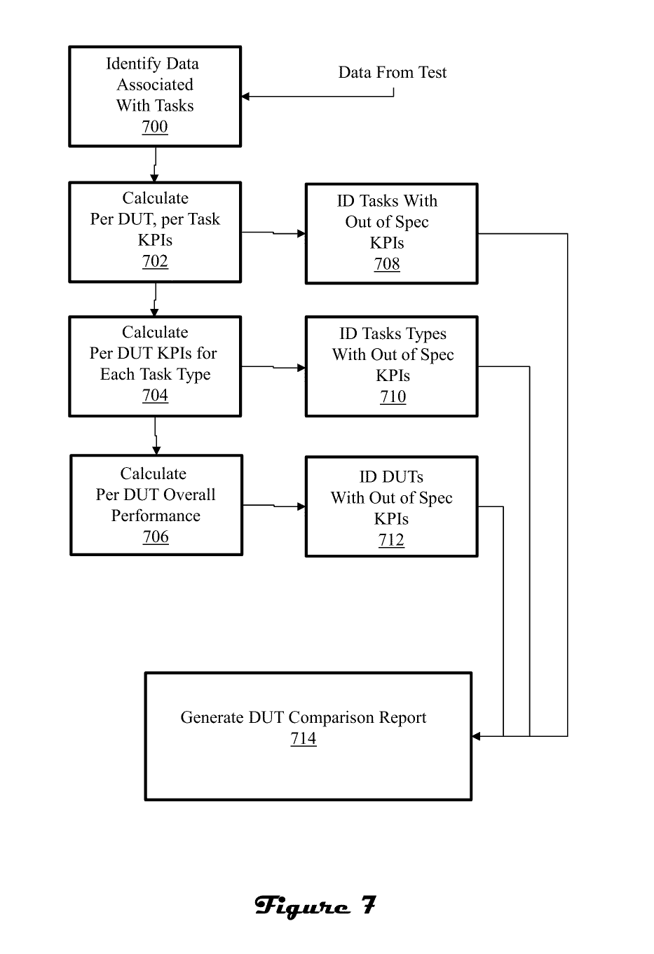

FIG. 7 illustrates aspects of processing data from a test (step 208, FIGS. 2 and 3) in greater detail. With reference to the synchronized DUT Logs 100 of FIG. 1, the log files are analyzed by software which automatically identifies data associated with specific tasks as indicated in step 700. The data associated with specific tasks for specific DUTs is utilized to calculate per DUT, per Task, Key Performance Indicators (KPIs) as indicated in step 702. A wide variety of KPIs may be calculated. The per DUT, per Task, KPIs can be used to calculate KPIs for each task type for each DUT as indicated in step 704. For example, the results of multiple video downloads (the same video or different videos) may be combined to produce KPIs which represent the video download task type performance of the DUT. The per DUT, per Task type, KPIs can be used to calculate KPIs for overall performance of each DUT as indicated in step 706. For example, the results of multiple different task types (or one task type) may be combined to produce KPIs which represent the overall performance of the DUT. Per DUT, per Task KPIs which do not fall within specification can be identified in step 708. Per DUT, per Task type KPIs which do not fall within specification can be identified in step 710. Per DUT, overall KPIs which do not fall within specification can be identified in step 712. The KPIs and identifications of out-of-spec KPIs are used to generate a DUT comparison report as indicated by step 714.

In the case where there are differences between the synchronized tasks the calculation and ID functions may include instructions associated with those differences. For example, if identical DUTs perform the same tasks over different networks then per network KPIs may be calculated for each task and task type, as well as overall network performance. Further, if different DUTs perform the equivalent or similar tasks over different networks then per service offering KPIs may be calculated for each task and task type, as well as overall network performance. Note that the system allows the operator to determine which aspects to hold constant so that other variable aspects can be meaningfully compared. It follows that the system is not limited to comparison of wireless devices and may be utilized to compare a wide variety of aspects related to network performance while mitigating otherwise uncontrolled aspects associated with OA testing.

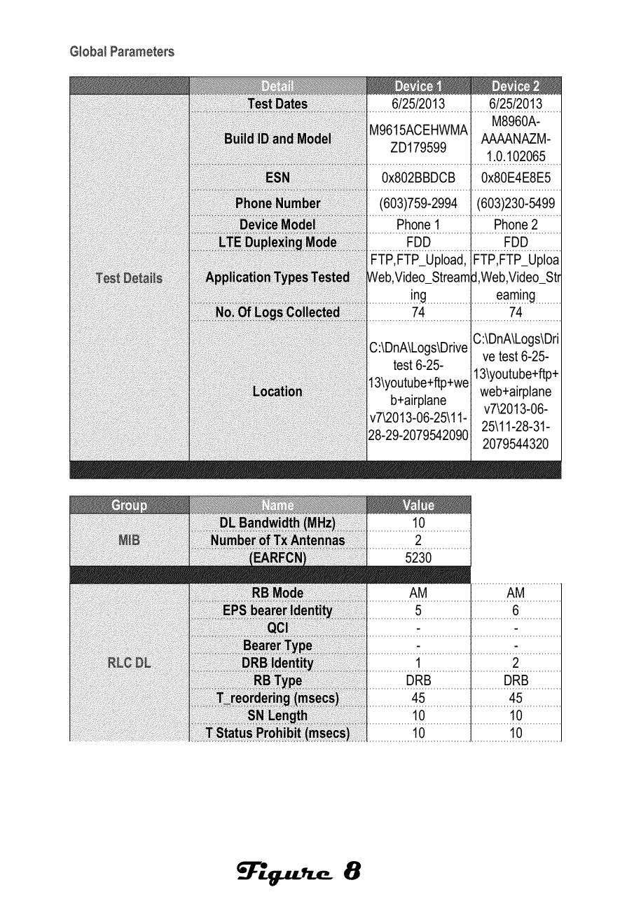

FIGS. 8 through 18 illustrate truncated pages of a DUT comparison report which could be generated in step 714 (FIG. 7). The report facilitates a meaningful, side-by-side comparison of two or more DUTs. The report may include different pages, windows or interfaces as described in greater detail below.

As shown in FIG. 8, one page, window or interface may present global parameters. In the illustrated example various parameters are listed in separate columns for each DUT in the test, e.g., Device 1 and Device 2. The parameters may include test dates, build ID and model, electronic serial number (ESN), phone number, device model, Long Term Evolution (LTE) duplexing mode, task types tested, number of logs collected and location. Additional parameters which may be grouped by uplink and downlink include Bandwidth, number of transmitter antennas, Evolved Absolute Radio Frequency Channel Number (EARFCN), Resource Block (RB) Mode, Evolved Packet switched System (EPS) bearer identity, Quality of Service (QoS) Class Identifier (QCI), bearer type, Data Radio Bearer (DRB) identity, RB type, T_reordering, SN length, T status prohibit.

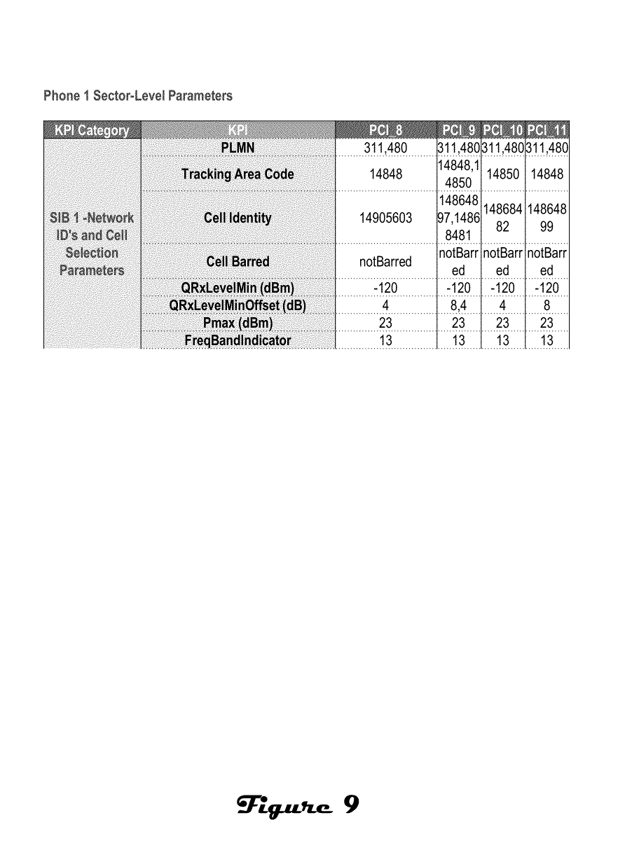

As shown in FIG. 9, sector-level KPIs for an individual DUT may be presented on another page, window or interface. The KPIs may be grouped. For example, one group might include various network IDs and cell selection parameters. Another group might include access class barring, Random Access Channel (RACH), Broadcast Control Channel (BCCH), Physical Downlink Shared Channel (PDSCH), Physical Uplink Control Channel (PUCCH), Physical Uplink Shared Channel (PUSCH), and power control parameters. Another group might include UE timers and constants. Another group might include cell reselection parameters. Another group might include Media Access Control (MAC) configuration parameters. Another group might include common handover parameters. Further groups might include handover parameters for specific events.

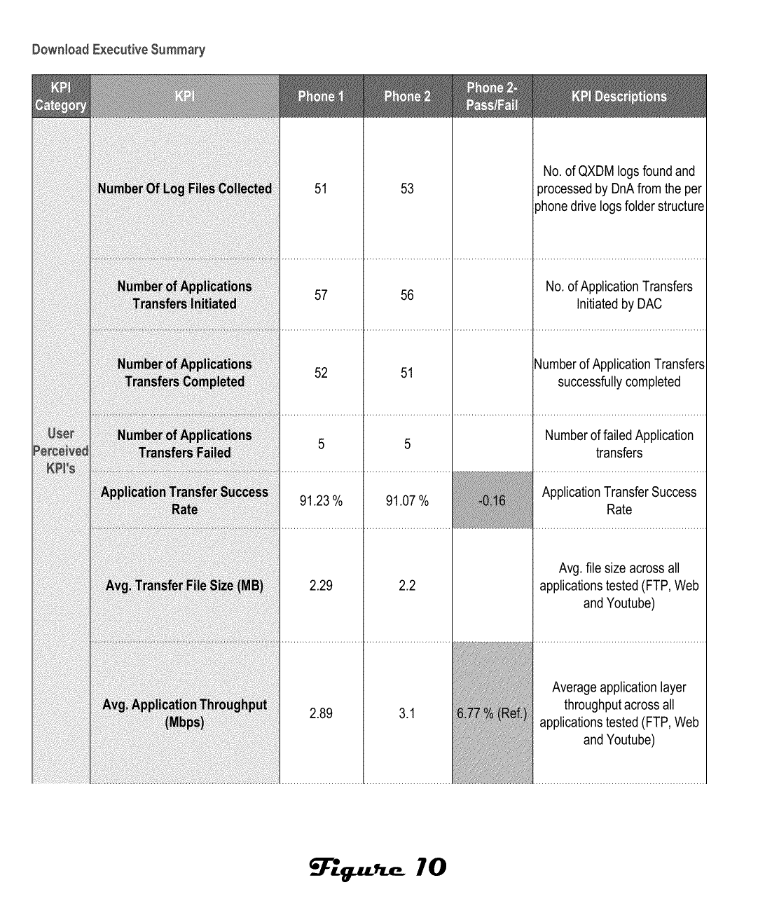

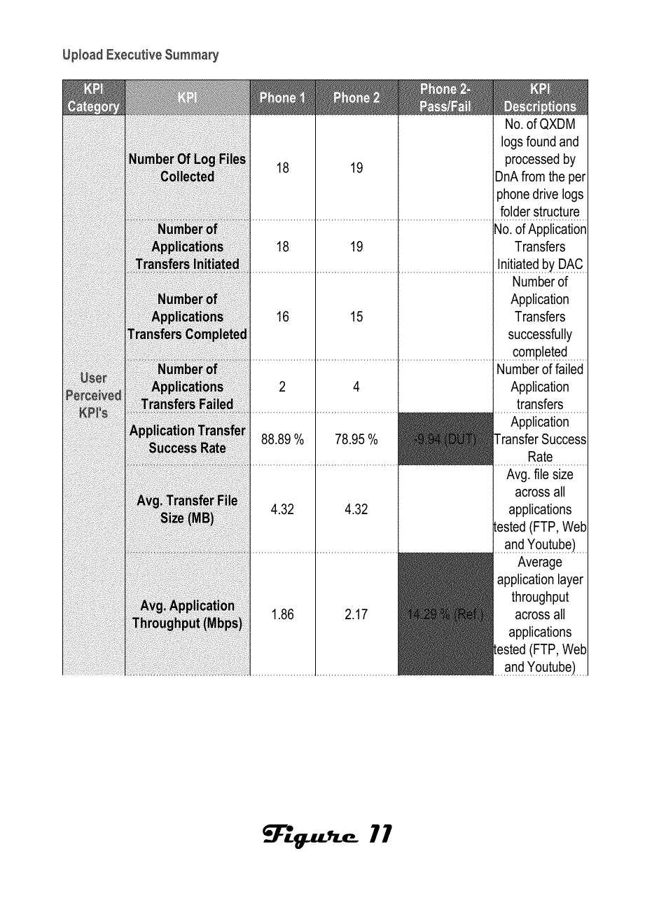

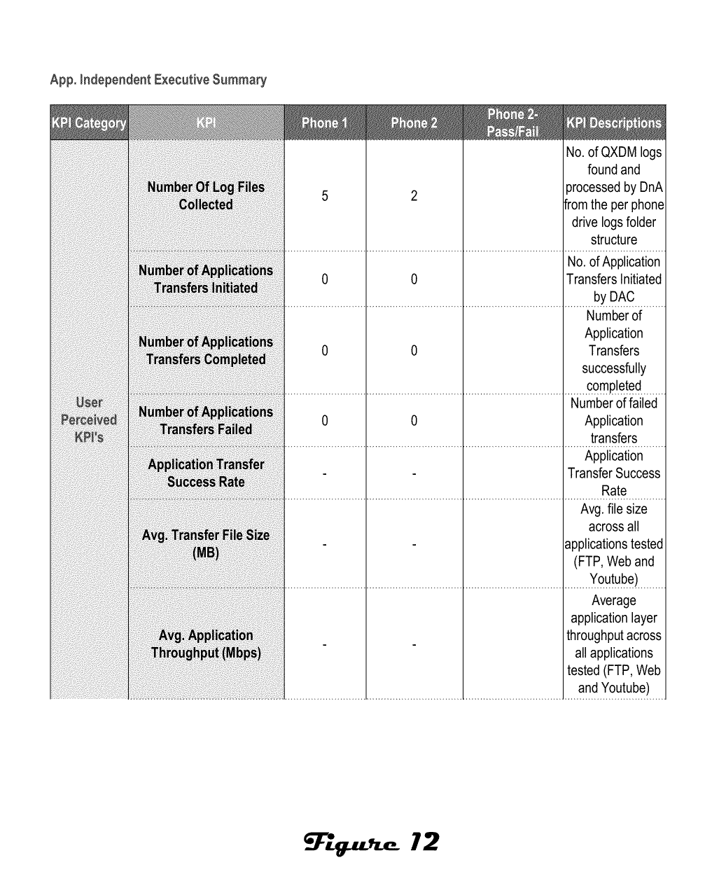

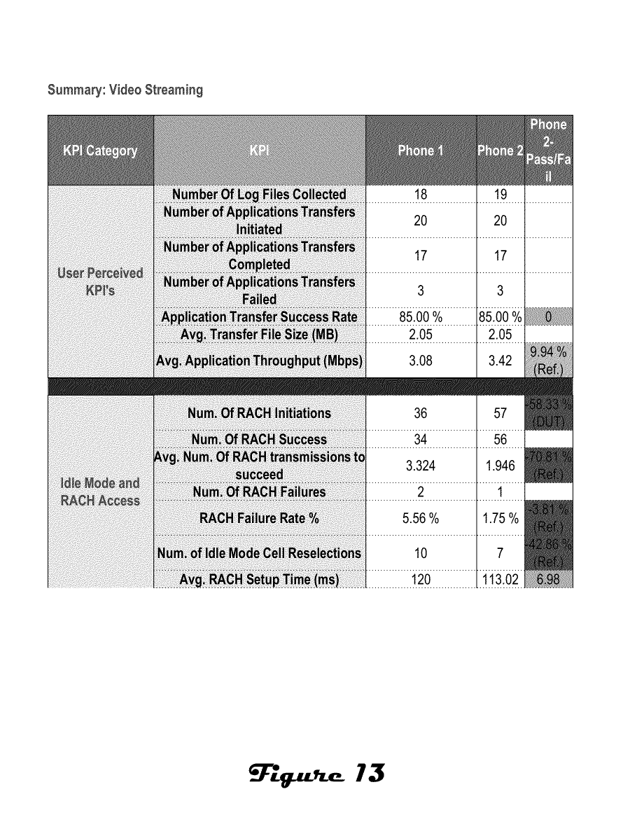

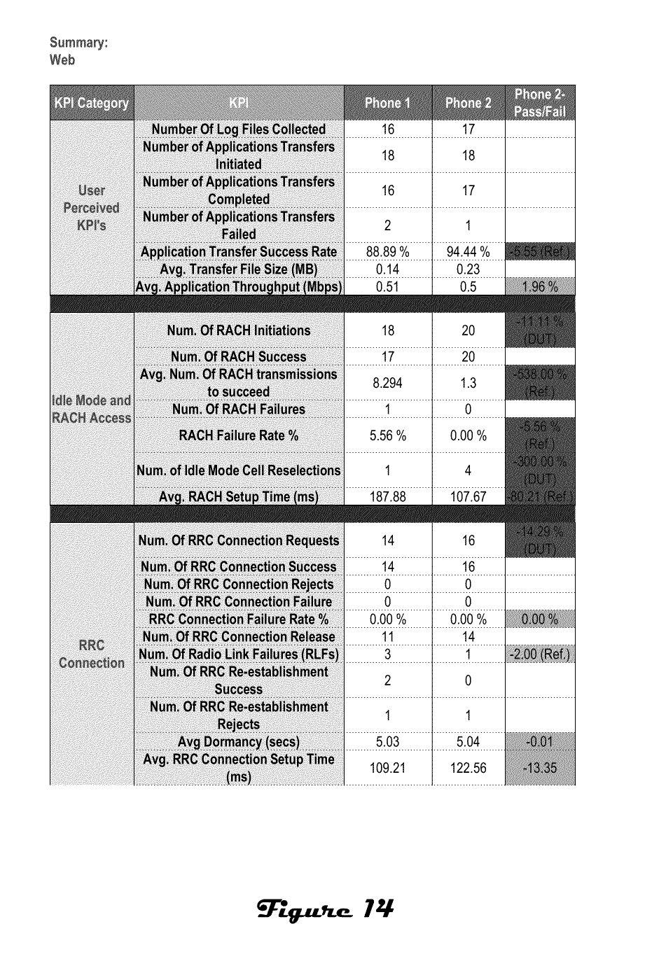

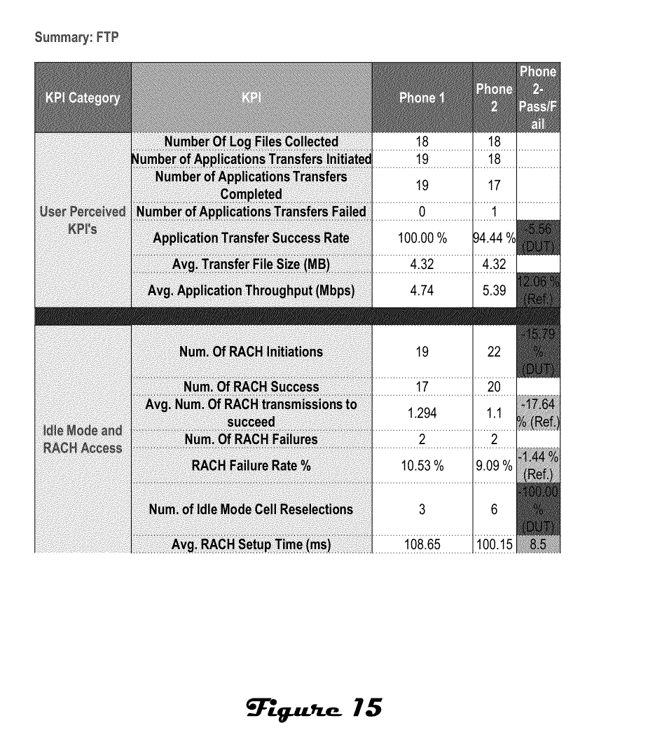

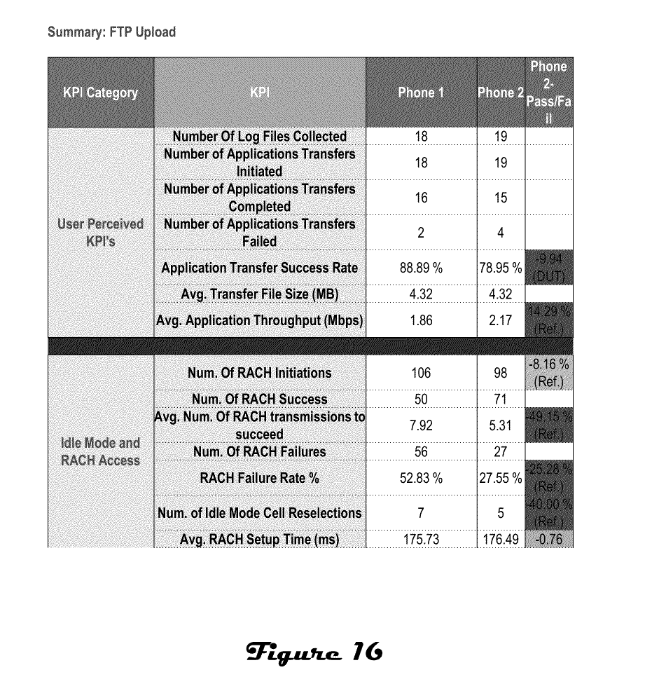

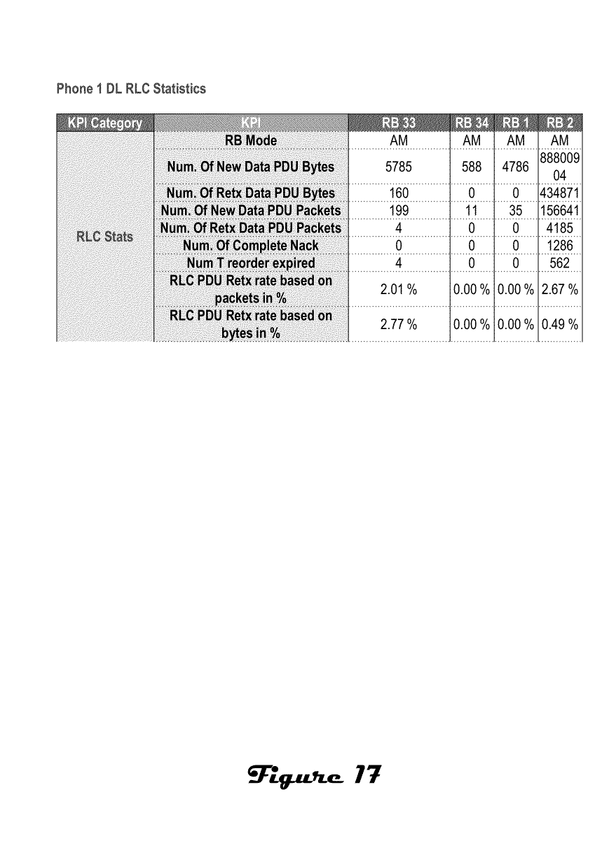

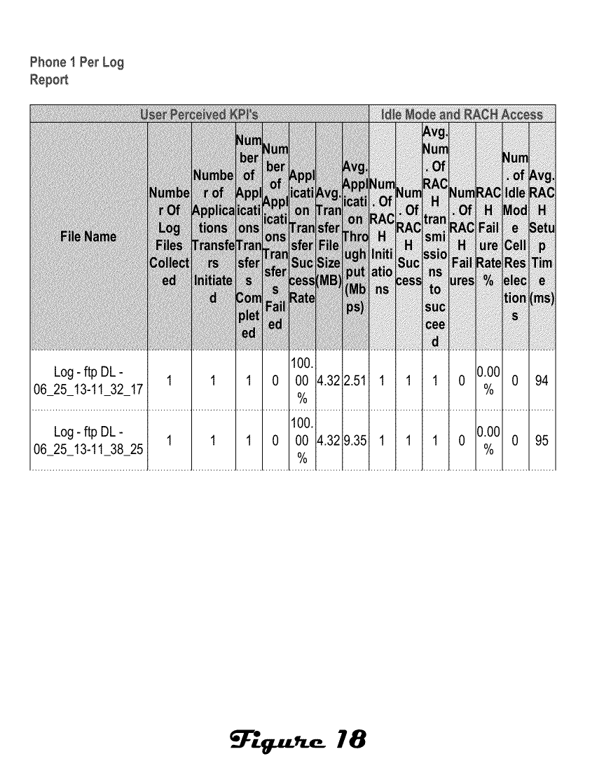

As shown in FIGS. 10 through 18, a separate page, window or interface may present each of a download summary (FIG. 10), an upload summary (FIG. 11), an application-independent executive summary (FIG. 12), task type summaries such as a video streaming summary (FIG. 13), a web page download summary (FIG. 14), a FTP summary (FIG. 15), an FTP upload summary (FIG. 16), RLC statistics (FIG. 17), and log report statistics (FIG. 18). Each summary may include various user-perceived KPIs, idle mode and RACH access KPIs, Radio Resource Control (RRC) connection KPIs, Inter-Radio Access Technology (IRAT) HO KPIs, attach KPIs, LTE handover KPIs, DL physical layer KPIs, DL MIMO and link adaptation KPIs, DL MAC scheduling KPIs, DL Radio Link Control (RLC) KPIs, battery impacts, UL physical layer and link adaptation KPIs, UL MAC layer KPIs, UL RLC KPIs, and tracking area update statistic KPIs.

A wide variety of KPIs may be included in the user-perceived KPI grouping. For example, the user perceived KPIs may include number of logs collected, number of application transfers initiated, number of application transfers completed, number of application transfers failed, transfer success rate, average transfer file size, and average throughput. The number of logs collected may indicate the number of diagnostic (e.g., QXDM) logs found and processed from the per DUT drive logs. The number of transfers initiated may indicate the number of application transfers initiated by the DAC. The average transfer file size may indicate average file size across all applications tested (e.g., FTP, Web and You Tube). The throughput may indicate average application layer throughput across all applications tested (e.g., FTP, Web and You Tube).

The idle mode and RACH access KPI grouping may include RACH initiations, RACH successes, average number of RACH transmissions to succeed, number of RACH failures, RACH failure rate %, number of idle mode cell reselections, and average RACH setup time. The RACH initiations may indicate the total number of RACH initiations from the UE. Reasons for RACH initiation include RRC connection requests, handovers, RLF and arrival of UL/DL data in a non-synchronized state. RACH success may indicate the total number of times that the RACH process was successful, i.e., contention resolution was successful. The RACH transmissions may indicate the average number of RACH preambles sent per RACH initiation before the RACH process is declared successful. A higher number suggest that the UE is using more power for access. Increased power usage has an influence on battery life and RL interference at the base-station. The number of RACH failures can indicate the total number of times the RACH process is aborted by the UE. This can occur due to reaching the maximum number of preamble transmissions or because of expiry of timers such as T300 and T304. A higher number of aborts may suggest that the UE was unable to connect to the network for new connections, handovers, etc., and possibly sending more RACH attempts at higher power and impacting battery life. The RACH failure rate may indicate the number of RACH aborts compared to the number of RACH initiations expressed as a percentage. The idle mode reselections may indicate the total number of idle mode handovers completed by the UE. The setup time may indicate the average time to successfully complete RACH processing (measured from RACH initiation to contention resolution), which directly influences connection setup time, handover time, etc.

The RRC connection KPI grouping may include RRC connection requests, RRC connection successes, RRC connection rejects, RRC connection failures, RRC connection failure rate, RRC connection releases, Radio Link Failures (RLF5), RRC re-establishment successes, RRC re-establishment rejections, average dormancy, and average RRC connection setup time. The connection requests may indicate the total number of RRC connections initiated by the UE. Associated reasons may include MO-data, MT-data, MO-signaling etc. Connection success may indicate the total number of RRC connections successfully established by the UE. A connection is declared successful when the UE receives the RRCConnectionSetup message and responds with a RRCConnection Setup Complete Message. Connection rejects indicates the total number of RRC connections that were rejected by the network. Connection failures may indicate the total number of RRC connections that failed due to T300 timer expiry. The T300 timer defines the amount of time that the UE waits for a RRC connection setup message before declaring the connection to be failed. Connections may fail due to a related RACH failure or other reasons. The connection failure rate may indicate the number of RRC connection failures due to T300 timer expiry compared to the number of RRC connection requests. The connection release may indicate the total number of RRC connections successfully closed by the network by sending an RRC Connection Release message to the UE. The RLFs may indicate the total number of instances where the UE experienced a Radio Link Failure (could be due to T310 timer expiry, RACH failure in connected mode, handover failure etc.) and was able to reselect to a suitable cell within T311 timer and send an RRC connection reestablishment message to that cell. The reestablishment success may indicate the total number of RRC connection reestablishments that were successful after a Radio Link Failure. The reestablishment rejects may indicate the total number of RRC connection reestablishment requests that were rejected by the network. The dormancy may indicate the average time taken to release an RRC connection (initiated due to MO-data or MO-data only and does not include mo-signaling) after the UE is done with its data transfer. The connection setup time may indicate average time to successfully establish an RRC connection (From RRC connection request to RRC connection setup complete). This setup time is directly influenced by the RACH setup time because RACH is one of the initial steps triggered by the RRC connection request.

The IRAT HO KPI grouping may include active mode data redirects to 3G/2G, active mode data HO to 3G/2G, MO CSFB extended service requests, MT CSFB extended service requests, CSFB responses, 4G to 3G/2G handovers, estimated time UE was on LTE network, estimated time UE was on 3G network, and % of Time UE was camped on LTE network as compared to 1xEVDO. The active mode redirects may indicate the total number of active mode data redirects from LTE to 3G/2G networks. This KPI may be based on a redirect message from the LTE network. The active mode data may indicate the total number of active mode Data HO from LTE to 3G/2G networks. This KPI may be based on MobilityFromEUTRA Command from LTE network. The extended service requests may indicate the total number of Mobile Originating Extended Service Requests for CS (Circuit Switched) Fallback (CSFB) and the total number of Mobile Terminating Extended Service Requests for CS Fallback. The responses may indicate the total number of CSFB responses from the LTE network in response to CSFB Service requests. This KPI may indicate the number of times the UE falls back to the 3G/2G network for Voice Calls. The handovers may indicate the total number of instances where the UE was on the 4G LTE network and had to handover to the 3G network due to redirection from the network in connected mode or due to idle mode reselection algorithms. This KPI may capture both intended and unintended 4G to 3G handovers. The time counts may indicate the total time the UE spent on the LTE network, the total estimated time the UE was on the 3G 1xEVDO network (mins), and % of time the UE was on LTE network as compared to the 1xEVDO network.

The attach KPI grouping may include attach requests, attach successes, attach failures, attach failure rate %, and average attach time. The attach requests may indicate the total number of attach requests sent by the UE to the MME to register with the network. The attach successes may indicate the total number of times where the attach process was successful as signaled by the UE receiving the attach accept from the network and responding with an attach complete message. The attach failures may indicate the total number of times where the attach accept message was not received from the network within T3410 timer expiry. The average attach time may indicate the average time taken to attach to the network (from the UE sending the attach request to UE responding with an attach complete message).

The LTE handover KPI grouping may include UL measurement reports for each event, intra-frequency handover requests, intra-frequency handover successes, intra-frequency handover failures, intra-frequency handover failure rate, average intra-frequency handover time, inter-frequency handover requests, inter-frequency handover successes, inter-frequency handover failures, inter-frequency handover failure rate, average inter-frequency handover time, and average DL handover interruption time. The UL measurement reports may indicate the total number of measurement reports sent by the UE due to criteria described in the event (e.g., A3, A2) message. Intra-frequency requests may indicate the total number of intra-frequency handover requests sent by the network to the UE based on the appropriate RRC Reconfiguration message. The successes may indicate the total number of intra-frequency handovers successfully completed by the UE based on UE successfully completing the RACH process with T304 and sending the RRC reconfiguration complete message to the target cell. The failures may indicate the total number of intra-frequency handover failures including instances where the UE failed to complete the RACH process on the target cell as well as the scenario where the UE was not even able to camp on the target cell within the T304 timer of receiving the relevant handover request message. The failure rate may indicate the number of intra-frequency handover failures relative to the number of handover requests initiated by the network. The handover time may indicate the average time to successfully complete intra frequency handover from appropriate RRC reconfiguration message to successfully completing the RACH process on the target cell and sending the RRC reconfiguration complete message. The requests may indicate the total number of inter-frequency handover requests sent by the network to the UE based on the appropriate RRC Reconfiguration message. The successes may indicate the total number of inter-frequency handovers successfully completed by the UE based on the UE successfully completing the RACH process with T304 and sending the RRC reconfiguration complete message to the target cell. The failures may indicate the total number of inter-frequency handover failures. This KPI may capture instances where the UE failed to complete the RACH process on the target cell as well as the scenario where the UE was not even able to camp on the target cell within T304 timer of receiving the relevant handover request message. The rate may indicate the number of inter-frequency handover failures relative to the number of handover requests initiated by the network. The handover time may indicate average time to successfully complete inter-frequency handover from appropriate RRC reconfiguration message to successfully completing the RACH process on the target cell and sending the RRC reconfiguration complete message. The interruption time may indicate the average time difference between the last packet received by the UE before handover start and the first packet received by the UE after handover completion on any Data Radio Bearer. A relatively higher number may suggest that the UE is not actively receiving DL data.

The DL physical layer KPI grouping may include average DL physical layer bytes, average DL retransmission discard rate, DL retransmission discard total, average RSRP for each antenna, average RSRQ for each antenna, average RSSI for each antenna, average SNR for each antenna, and DL physical layer burst rate. The physical layer bytes may indicate the average of the total number of physical layer bytes received by the UE in the downlink from different log files. Differences between DUTs may be due to logged packet drops. The discard rate may indicate the average DL Retransmission Discarded Rate as a percentage. The total bytes may indicate total retransmitted bytes discarded by the UE. This KPI may suggest misinterpretation of UE ACK as a NACK in the UL due to which eNodeB retransmits the bytes that the UE already has received successfully and hence discards. The average RSRP fields may indicate average Reference Signal Received Power measured by the UE on different antennas (e.g., Ant 0, Ant 1). These KPIs may be used by the UE for SNR computation and handover evaluation. The RSRQ fields may indicate the average Reference Signal Received Quality measured by the UE on different antennas. The RSSI fields may indicate the average Received Signal Strength Indicator measured by the UE on different antennas. The SNR fields may indicate the average Signal to Noise Ratio measured by the UE on different antennas. The KPI can be used to evaluate the channel quality feedback sent by the UE to the network. The burst rate may indicate pure over the air throughput computed only over intervals where the user was scheduled. This KPI suggests UE receiver PHY throughput performance that is not colored by MAC scheduling, upper layer effects related to RLC, TCP etc.

The DL MIMO and link adaptation KPI grouping may include average CQI requested, average rank delivered, average DL MCS, average rank requested, DL BLER %, DL HARQ performance, average CQI requested, and average DL MCS. The CQI requested fields may indicate average of all the Wideband CQI values sent by the UE for different CodeWord and Rank transmissions. The values may include transmissions sent on both PUCCH and PUSCH. The average CQI fields can indicate averages of all the Wideband CQI values sent by the UE for different CodeWord and Rank transmissions, including transmissions sent on both PUCCH and PUSCH. The average rank delivered may indicate the average number of spatial layers (Rank) that were scheduled by the network to the UE for downlink data transfer. The average DL MCS fields may indicate the average DL MCS values of all the downlink packets (C-RNTI only) scheduled to the UE for different Codeword and Rank transmissions. MCS is chosen by the network based on many factors including the channel feedback and a higher SINR, and related CQI should generally lead to higher MCS and hence higher physical layer burst rate. The average rank requested may indicate the average spatial layers requested by the UE based on the channel estimate and conditions measured by the UE on each antenna. The DL BLER % may indicate downlink Block Error Rate as a ratio of total number of Phy layer packets received in error to the total number of Phy layer packets received. A relatively high BLER may lead to upper layer retries and hence may correlate to higher RLC layer re-transmissions. Higher than expected BLER may suggest poor receiver design, power control issues, or poor CQI to channel mapping. The HARQ performance field may indicate the rate of successfully decoding Phy layer packets by the UE using 1, 2, 3 or 4 Hybrid ARQ transmissions from the network. These KPI's denote the rate of successfully decoding packets for each Redundancy Version (RV) of the Phy layer packet sent by the network. Note that networks may send HARQ transmissions in a different RV order. For example, one network may use RV 0 followed by RV's 2, 3 and 1, whereas another network may use RV 0 followed by 1, 2, and 3. The CQI requested may indicate the overall average of all the Wideband CQI values sent by the UE regardless of the Rank of transmission. The average MCS may indicate the overall average of all the DL MCS values for all the downlink C-RNTI based packets scheduled to the UE regardless of the transmission rank from the network.

The DL MAC scheduling KPI grouping may include average time to transfer, DL sub-frame usage, and average resource block assigned. The time to transfer indicates average time to transfer data across all applications tested (FTP, Web and Youtube). The sub-frame usage is a time domain scheduling KPI that captures the ratio of the total number of sub-frames where data was scheduled to the UE to the total time it took to complete the data transfer. A low number may suggest inappropriate multi-user scheduling by the network, data getting stalled for the user at higher layers, or insufficient statistical samples. The resource blocks assigned is a frequency domain scheduling KPI that denotes the average number of Resource blocks scheduled to the UE for its data transfer.

The DL RLC KPI grouping may include number of new data PDU bytes, number of retransmitted data PDU bytes, number of new data PDU packets, number of retransmitted data PDU packets, number of complete Nacks, Num T reorder expired, RLC PDU retransmission rate based on packets, and RLC PDU retransmission rate based on bytes. The new data PDU bytes indicates total number of new data bytes received by the UE at the RLC layer. The retransmitted data PDU bytes indicates total number of re-transmitted bytes received by the UE based on RLC layer re-transmissions. RLC re-transmissions are typically required due to failure in decoding Phy layer packets after exhausting all HARQ re-transmissions. The new data PDU packets indicates total number of new data packets received by the UE at the RLC layer. The retransmitted data PDU packets indicates the total number of retransmitted packets received by the UE based on RLC layer re-transmissions. RLC re-transmissions are typically required due to failure in decoding Phy layer packets after exhausting all HARQ re-transmissions. The complete Nack field indicates the total number of complete Nacks sent by the UE to request for RLC re-transmission. The reorder expired field indicates the total number of instances where RLC PDU's were received out of sequence and the in-sequence delivery of those PDUs was not completed before the expiry of the T-reordering timer. The retransmission rate fields indicate the total number of RLC re-transmitted data packets divided by the total number of New RLC data packets and bytes. A high RLC re-transmission rate may be related to high DL BLER.

The battery impacts grouping may include average CFI, PDCCH searches, and successful PDCCH decodes. The average CFI indicates an average number of OFDM symbols/sub-frames that are used by the network for PDCCH transmission. A relatively higher number here suggests lesser OFDM symbols are available for data transmission and hence affects network capacity. The PDCCH searches field indicates the total number of PDCCH searches performed by the UE as part of the blind decoding algorithm in an attempt to decode Downlink Control Information (DCI). A relatively higher number of such searches may degrade battery life. The PDCCH decodes field indicates the total number of Downlink Control Information (DCI) decoded by the UE during blind decoding search process.

The UL physical layer and link adaptation KPI grouping may include average UL physical layer bytes, average PUCCH transmit power, average PUSCH transmit power, average UL MCS, UL BLER %, UL HARQ performance, and UL physical layer burst rate. The Phy layer bytes indicates an average of the total number of physical layer bytes sent by the UE in the uplink from different log files. The PUCCH transmit power field indicates an average power used by the UE for transmitting the PUCCH. Relatively higher power usage may suggest reduced battery life and RL interference. The PUSCH transmit power field indicates an average power used by the UE for transmitting the PUSCH. Relatively higher power usage may suggest reduced battery life and RL interference. The UL MCS field indicates an average MCS value of all uplink physical layer packets sent by the UE. The UL BLER field indicates Uplink Block Error Rate, which denotes a ratio of total number of Physical layer re-transmits by the UE to the total number of phy layer packets sent. A relatively high BLER may lead to upper layer retries and hence correlate to higher RLC layer re-transmissions. The HARQ performance field indicates the rate of successfully sending Phy layer packets by the UE using 1, 2 or 3 Hybrid ARQ transmissions. These KPIs denote the rate of successfully decoding packets for each re-transmission index/RV of the Phy layer packet sent by the UE. The burst rate field indicates pure over the air UL throughput without accounting for upper layer effects related to RLC, TCP etc. For download applications this number may show up to be small because relatively little data related to TCP Acks is in the uplink for a downlink data transfer.

The UL MAC layer KPI grouping may include PUSCH sub-frame usage, PUCCH sub-frame usage, average UL RB, average BSR indicator, average buffer occupancy, and average PHR indicator. The PUSCH sub-frame field is a time domain scheduling KPI that captures the ratio of the total number of sub-frames where data was sent by the UE on the PUSCH to the total time it took to complete the data transfer. The PUCCH sub-frame field indicates the ratio of the total number of sub-frames where control signaling such as CQI was sent by the UE on the PUCCH to the total time it took to complete the data transfer. The UL RB field indicates the average number of Resource blocks scheduled to the UE in the UL for its data transfer. The BSR indicator provides the average of the buffer status report indicator for various Logical channel IDs. The buffer occupancy indicates an average of the buffer status report bytes for various Logical channel IDs. The PHR indicator provides an average of all the Power Headroom reports sent by the UE.

The UL RLC KPI grouping may include new data PDU bytes, retransmitted PDU bytes, new data PDU packets, retransmitted data PDU packets, complete Nacks, RLC PDU retransmission rate based on packets, and RLC PDU retransmission rate based on bytes. The new data PDU bytes indicates the total number of new data bytes sent by the UE at the RLC layer. The number of retransmitted data PDU bytes indicates the total number of re-transmitted bytes sent by the UE based on RLC layer re-transmissions. RLC re-transmissions are typically required due to failure in decoding Phy layer packets by the network after exhausting all HARQ re-transmissions. The new data PDU packets indicates the total number of new data packets sent by the UE at the RLC layer. The retransmitted data PDU packets indicates the total number of re-transmitted packets sent by the UE based on RLC layer re-transmissions. RLC re-transmissions are typically required due to failure in decoding Phy layer packets by the network after exhausting all HARQ re-transmissions. The Nack field indicates the total number of complete Nacks received by the UE. The RLC PDU transmit rate fields indicate the total number of RLC re-transmitted data packets and bytes divided by the total number of New RLC data packets and bytes, respectively. A relatively high RLC re-transmit rate may be related to high UL BLER

The tracking area update statistic KPI grouping may include track area update requests, track area update success, track area update failures, and track area update failure rate. The update request field indicates the total number of tracking area updates sent by the UE. Underlying reasons may include timer expiry, change of TAC's etc. The update success field indicates the total number of times where the TAU procedure was successfully completed within the T3430 timer and is indicated by the reception of a TAU accept message from the network and a response of a TAU complete message from the UE. The update failures field indicates the total number of times where the TAU accept message was not received by the UE within T3430 time of sending the TAU request message. The failure rate percentage is Total Tracking Area Failures/Total Tracking Area Requests.

A number of implementations have been described. Nevertheless, it will be understood that additional modifications may be made without departing from the scope of the inventive concepts described herein, and, accordingly, other aspects, implementations, features and embodiments are within the scope of the following claims.

What is claimed is:

1. A method comprising:
simultaneously testing a plurality of wireless devices which communicate with at least one other device using a test which includes a plurality of tasks by:
synchronizing commencement of corresponding comparative tasks by all wireless devices;
logging performance of each wireless device during the test;
calculating values of at least one performance indicator for each wireless device for at least one of the tasks; and
providing an output which compares the performance indicators.

2. The method of claim 1 wherein calculating said values comprises calculating values of at least one performance indicator for each wireless device for multiple tasks of a selected type.

3. The method of claim 2 wherein calculating said values comprises calculating values of at least one overall performance indicator for each wireless device for multiple tasks of multiple selected types.

4. The method of claim 1 including identifying per task performance indicators having predetermined out-of-specification characteristics.

5. The method of claim 2 including identifying per task type performance indicators having predetermined out-of-specification characteristics.

6. The method of claim 3 including identifying overall performance indicators having predetermined out-of-specification characteristics.

7. A computer program stored on non-transitory computer-readable memory comprising:
instructions which cause a plurality of wireless devices which communicate with at least one other device to be simultaneously tested using a test which includes a plurality of tasks, and comprising instructions which:
synchronize commencement of corresponding comparative tasks by all wireless devices;
log performance measurements of each wireless device for each task;
calculate values of at least one performance indicator for each wireless device for at least one of the tasks; and
provide an output which compares the performance indicators.

8. The computer program of claim 7 wherein the instructions calculate values of at least one performance indicator for each wireless device for multiple tasks of a selected type.

9. The computer program of claim 8 wherein the instructions calculate values of at least one overall performance indicator for each wireless device for multiple tasks of multiple selected types.

10. The computer program of claim 7 wherein the instructions identify per task performance indicators having predetermined out-of-specification characteristics.

11. The computer program of claim 8 wherein the instructions identify per task type performance indicators having predetermined out-of-specification characteristics.

12. The computer program of claim 9 wherein the instructions identify overall performance indicators having predetermined out-of-specification characteristics.

13. Apparatus comprising:
a test system in which a plurality of wireless devices which communicate with at least one other device are simultaneously tested using a test which includes a plurality of tasks, comprising one or more devices which:
synchronize commencement of corresponding comparative tasks by all wireless devices;
log performance measurements of each wireless device for each task;
calculate values of at least one performance indicator for each wireless device for at least one of the tasks; and
provide an output which compares the performance indicators.

14. The apparatus of claim 13 wherein the one or more devices calculate values of at least one performance indicator for each wireless device for multiple tasks of a selected type.

15. The apparatus of claim 14 wherein the one or more devices calculate values of at least one overall performance indicator for each wireless device for multiple tasks of multiple selected types.

16. The apparatus of claim 13 wherein the one or more devices identify per task performance indicators having predetermined out-of-specification characteristics.

17. The apparatus of claim 14 wherein the one or more devices identify per task type performance indicators having predetermined out-of-specification characteristics.

18. The apparatus of claim 15 wherein the one or more devices identify overall performance indicators having predetermined out-of-specification characteristics.
